(19) United States
(12) Patent Application Publication
(10) Pub. No.: US 2008/0313693 A1
(43) Pub. Date: Dec. 18, 2008

(54) SET TOP BOX, DIGITAL BROADCAST VIEWING SYSTEM, AND METHOD OF CONTROLLING DIGITAL BROADCAST VIEWING SYSTEM

(76) Inventor: Naoki MIYANO, Osaka (JP)

Correspondence Address: NIXON & VANDERHYE, PC, 901 NORTH GLEBE ROAD, 11TH FLOOR, ARLINGTON, VA, 22203, US

(21) Appl. No.: 12/053,811

(22) Filed: Mar. 24, 2008

(30) Foreign Application Priority Data
Jun. 12, 2007 (JP) 2007-155545

(51) Int. Cl. H04N 7/173

(52) U.S. Cl. 725/131

(57) ABSTRACT

A set top box in combination with an analog TV 1, forming a digital broadcast viewing system includes: a digital tuner unit (5) for digital broadcast reception; output terminals (8) and (9) for externally outputting a signal based on an output signal of the digital tuner unit 5; and a blocking part 3 for covering a light receiving part 1P of the analog TV 1 to prevent the light receiving part 1P of the analog TV 1 from directly receiving a signal transmitted from an analog TV remote control transmitter 20.

This nonprovisional application claims priority under 35 U.S.C. §119(a) on Patent Application No. 2007-155545 filed in Japan on Jun. 12, 2007, the entire contents of which are hereby incorporated by reference.

### BACKGROUND OF THE INVENTION

1. Field of the Invention

The present invention relates to a set top box (STB), and more specifically to a set top box having a digital tuner unit. The present invention also relates to a digital broadcast viewing system including the set top box and an analog TV and a method of controlling the digital broadcast viewing system.

2. Description of Related Art

Ways to view digital broadcast, such as terrestrial digital broadcast, are broadly classified into: a way in which a conventional analog TV (having no built-in digital broadcast receiving tuner but having a built-in analog broadcast receiving tuber) is replaced with a digital TV (having a built-in digital broadcast receiving tuner); and a way in which, without replacing a conventional analog TV with a digital TV, a set top box having a digital tuner unit for digital broadcast reception is purchased and then a digital broadcast viewing system is built by connecting together an output terminal of the set top box and an external input terminal of an analog TV with a cable.

Selecting the latter method, that is, a set top box having a digital tuner unit is purchased and then a digital broadcast viewing system is built by connecting together an output terminal of the set top box and an external input terminal of the analog TV with a cable provides the viewer's hands with an analog TV remote control transmitter attached to the analog TV and a set top box remote control transmitter attached to the set top box.

Such presence of the two remote control transmitters is confusing and bothersome to the viewer. Moreover, a set top box remote control transmitter with a large number of operation keys is hard to operate. Thus, the viewer usually desire to perform remote control of the digital broadcast viewing system only with the single analog TV remote control transmitter which he or she is accustomed to use. This trend is more obvious in elderly people in particular.

Moreover, even when the analog TV selects external input and a digital broadcast program channel selected by the digital tuner unit in the set top box is produced on the analog TV, if a light receiving part of the analog TV receives an infrared transmission signal corresponding to channel selection operation performed on the analog TV remote control transmitter, the analog TV stops its selection of the external input, and an analog broadcast program channel selected by its own analog broad cast receiving tuner is produced on the analog TV. That is, there arises a problem that accidental switching to analog broadcast viewing occurs as a result of remote control operation of the analog TV remote control transmitter during digital broadcast viewing. Since the analog broadcast poses problems such as noise occurring in weak electric fields, the accidental switching from digital broadcast viewing to analog broadcast viewing is not preferable.

A broadcast receiver selection system disclosed in JP-A-2005-217587 and a digital broadcast receiving device disclosed in JP-A-2004-147066 do not include a set top box having a digital tuner unit and an analog TV having no built-in digital tuner unit. Therefore, the broadcast receiver selection system disclosed in JP-A-2005-217587 and the digital broadcast receiving device disclosed in JP-A-2004-147066 do not solve the problem described above.

With a digital tuner controller and control method disclosed in JP-A-2005-295263, a failure to prevent an infrared signal transmitted from an analog TV remote control transmitter from reaching a light receiving part on the analog TV side results in a failure to solve the problem described above, that is, the infrared signal transmitted from the analog TV remote control transmitter also reaches the light receiving part on the analog TV side, so that an analog broadcast program channel selected with an analog broadcast receiving tuner of the analog TV is produced on the analog TV,

### SUMMARY OF THE INVENTION

It is an object of the present invention to provide a set top box which forms a digital broadcast viewing system by being combined with an analog TV and which prevent accidental switching to analog broadcast viewing by remote control operation of an analog TV remote control transmitter during digital broadcast viewing in the aforementioned digital broadcast viewing system. Moreover, it is also an object of the invention to provide a digital broadcast viewing system including this set top box and an analog TV, and a method of controlling this digital broadcast viewing system.

To achieve the object described above, according to one aspect of the invention, a set top box for use in combination with an analog TV to form a digital broadcast viewing system includes: a digital tuner unit for digital broadcast reception; an output terminal for externally outputting a signal based on an output signal of the digital tuner unit; and a blocking part for covering a light receiving part of the analog TV to prevent the light receiving part of the analog TV from directly receiving a signal transmitted from an analog TV remote control transmitter.

With this configuration, the blocking part can cover the light receiving part of the analog TV to prevent the light receiving part of the analog TV from directly receiving the signal transmitted from the analog TV remote control transmitter. This therefore can prevent accidental switching to analog broadcast viewing from occurring as a result of remote control operation of the analog TV remote control transmitter during digital broadcast viewing in the digital broadcast viewing system. In the set top box according to the invention, the blocking part may be formed separately from a set top box main body.

It is preferable that the set top box described above include a remote control light receiving part receiving the signal transmitted from the analog TV remote control transmitter.

It is preferable that the aforementioned set top box including the remote control light receiving part receiving the signal transmitted from the analog TV remote control transmitter further include: a demodulation part demodulating an output signal of the remote control light receiving part to obtain remote control code data; a determination part determining, based on the remote control code data obtained by the demodulation part, whether or not the signal transmitted from the analog TV remote control transmitter is a signal transmitted when a predetermined operation key (for example, a volume adjustment key) of the analog TV remote control transmitter is pressed; and a transfer part, when the determination part determines that the signal transmitted from the analog TV remote control transmitter is the signal transmitted when the predetermined operation key of the analog TV remote control transmitter is pressed, restoring the signal transmitted from the analog TV remote control transmitter and transferring the signal to permit the light receiving part of the analog TV to directly receive the signal.

With this configuration, predetermined remote control can be performed on the analog TV without any problem. In the set top box according to the invention, the transfer part may be formed separately from a set top box main body, and the transfer part may also serve as a blocking part. Further, in order to prevent accidental switching to analog broadcast viewing, it is preferable that the predetermined key do not include an input switch key and a channel switch key.

It is preferable that aforementioned set top box including the remote control light receiving part receiving the signal transmitted from the analog TV remote control transmitter further include: a demodulation part demodulating an output signal of the remote control light receiving part to obtain remote control code data; a determination part determining, based on the remote control code data obtained by the demodulation part, whether or not the signal transmitted from the analog TV remote control transmitter is a signal transmitted when a channel switch key of the analog TV remote control transmitter is pressed; and a remote control code conversion and control part, when the determination part determines that the signal transmitted from the analog TV remote control transmitter is the signal transmitted when the channel switch key of the analog TV remote control transmitter is pressed, converting the remote control code data obtained by the demodulation part into set top box channel switching remote control code data and controls the digital tuner unit in accordance with the set top box channel switching remote control code data.

With this configuration, digital broadcast channel selection operation can be performed with the analog TV remote control transmitter.

To achieve the object described above, according to another aspect of the invention, a digital broadcast viewing system includes: the set top box described above; and an analog TV for externally receiving a signal outputted from an output terminal of the set top box.

To achieve the object described above according to still another aspect of the invention, a method of controlling a digital broadcast viewing system is formed by a combination of an analog TV and a set top box having a digital tuner unit for digital broadcast reception, and prevents a light receiving part of the analog TV from directly receiving a signal transmitted from an analog TV remote control transmitter.

In the method of controlling a digital broadcast viewing system described above. It is preferable that the set top box receive the signal transmitted from the analog TV remote control transmitter, demodulate the received signal to obtain remote control code data; determine, based on the obtained remote control code data, whether or not the signal transmitted from the analog TV remote control transmitter is a signal transmitted when a predetermined operation key of the analog TV remote control transmitter is pressed; and when it is determined that the signal transmitted from the analog TV remote control transmitter is the signal transmitted when the predetermined operation key of the analog TV remote control transmitter is pressed, restore the signal transmitted from the analog TV remote control transmitter and transfer the signal to permit the light receiving part of the analog TV to directly receive the signal. Further, to prevent accidental switching to analog broadcast viewing, it is preferable that the predetermined operation key do not include an input switch key and a channel switch key.

In the method of controlling a digital broadcast viewing system described above, it is preferable that the set top box: receive the signal transmitted from the analog TV remote control transmitter; demodulate the received signal to obtain remote control code data; determine, based on the obtained remote control code data, whether or not the signal transmitted from the analog TV remote control transmitter is a signal transmitted when a channel switch key of the analog TV remote control transmitter is pressed; and when it determines that the signal transmitted from the analog TV remote control transmitter is the signal transmitted when the channel switch key of the analog TV remote control transmitter is pressed, convert the remote control code data into set top box channel switching remote control code data and control the digital tuner unit in accordance with the set top box channel switching remote control code data.

According to the invention, a digital broadcast viewing system can be formed by a combination of an analog TV, and a set top box can be provided which prevents accidental switching to analog broadcast viewing from occurring as a result of remote control operation of the analog TV remote control transmitter during digital broadcast viewing in the digital broadcast viewing system. Moreover, a digital broadcast viewing system including this set top box and an analog TV and a method of controlling the digital broadcast viewing system can be provided.

### BRIEF DESCRIPTION OF THE DRAWINGS

FIG. 1 is a block diagram showing one configuration example of a digital broadcast viewing system according to the present invention;

FIG. 2 is a flow chart for control of a set top box according to the invention; and

FIG. 3 is a diagram showing key functions of an analog TV and the set top box according to the invention in accordance with key operation of an analog TV remote control transmitter.

### DETAILED DESCRIPTION OF PREFERRED EMBODIMENTS

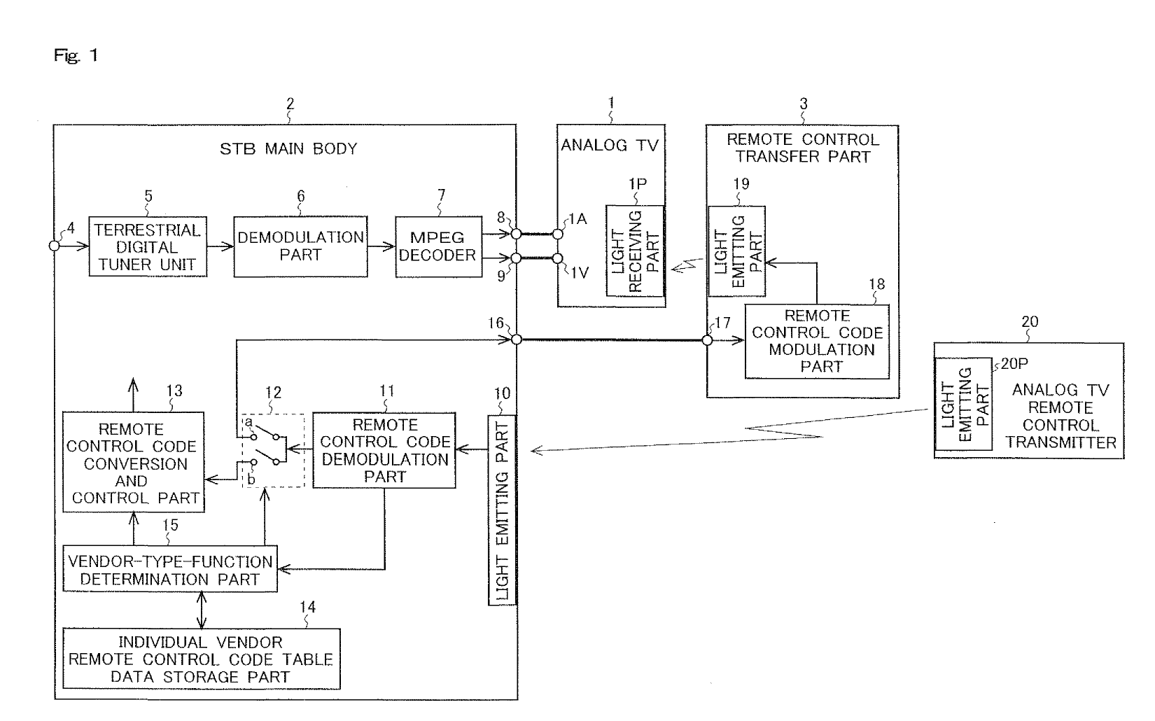

The embodiment of the present invention will be described, with reference to the accompanying drawings. FIG. 1 is a block diagram showing one configuration example of a digital broadcast viewing system according to the invention. The digital broadcast viewing system according to the invention shown in FIG. 1 is composed of an analog TV 1 and a set top box according to the invention. The set top box according to the invention is composed of a set top box main body 2 (hereinafter referred to as STB main body 2) and a remote control transfer part 3,

An analog TV remote control transmitter 20 attached to the analog TV 1 is provided for the viewer to perform remote control of the analog TV 1. The analog TV remote control transmitter 20 typically has a plurality of operation keys: for example, a power ON/OFF switch key; an input switch key; channel switch keys (channel UP key, channel DOWN key, numerical keys for direct channel selection); volume adjustment keys (volume UP key and volume DOWN key); and so on. When an arbitrary operation key is pressed, the analog TV remote control transmitter 20 modulates remote control code data assigned to the function of the pressed key, then converts it into an infrared signal, and then transmits it from a light emitting part 20P.

An STB remote control transmitter (not shown) attached to the set top box according to the invention is provided for the viewer to perform remote control of the set top box according to the invention. The STB remote control transmitter typically has: in addition to a power ON/OFF switch key and channel switch keys, operation keys such as program list and program information keys corresponding to a program list and program information which are specific to digital broadcast. Thus, the STB remote control transmitter has a larger number of operation keys than the analog TV remote control transmitter.

The STB main body 2, as its basic configuration, includes: an antenna input terminal 4, a terrestrial digital tuner unit 5, a demodulation part 6, an MPEG decoder 7, an audio signal output terminal 8, a video signal output terminal 9, a light receiving part 10, a remote control code demodulation part 11, a data-through switch 12, a remote control code conversion and control part 13, an individual vendor remote control code table data storage part 14, a vendor-type-function determination part 15, and a terminal 16.

The remote control transfer part 3, as its basic configuration, includes: a terminal 17, a remote control code modulation part 18, a light emitting part 19. The remote control transfer part 3 has the light emitting part 19 arranged oppositely to a light receiving part 1P of the analog TV 1. Further, the remote control transfer part 3 is so arranged as to cover the light receiving part IP of the analog TV 1 so that the light receiving part 1P of the analog TV 1 does not directly receive an infrared signal transmitted from the analog TV remote control transmitter 20.

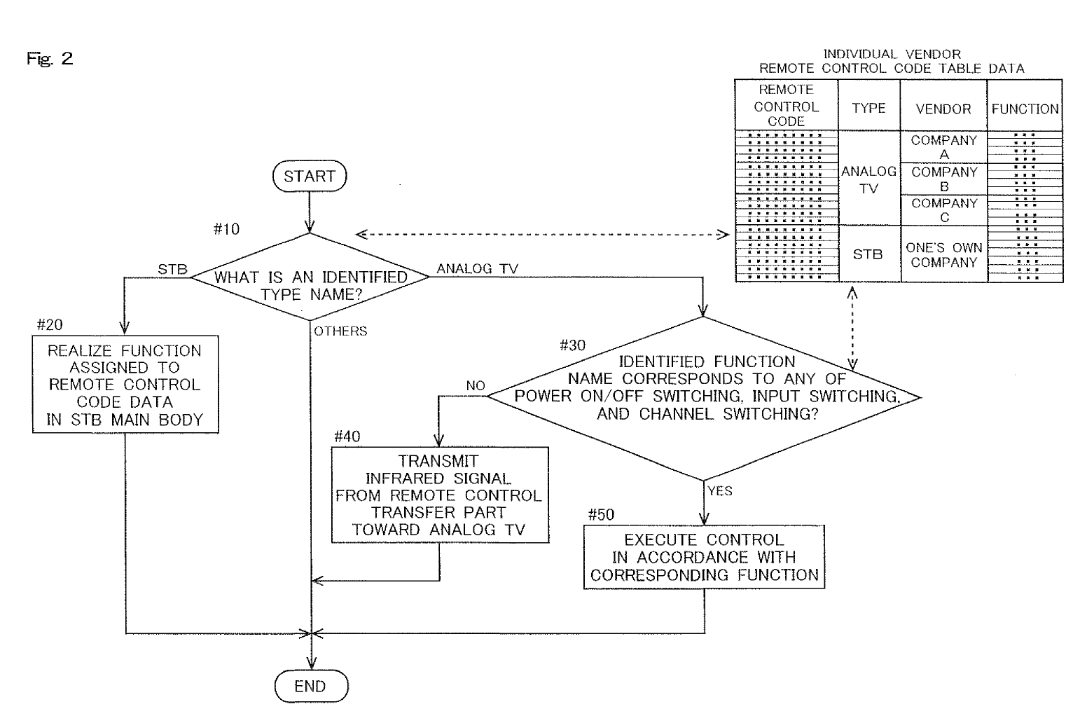

Hereinafter, operation of the set top box according to the invention composed of the STB main body 2 and the remote control transfer part 3 will be described, with reference to the block diagram shown in FIG. 1 and a flowchart for control of the set top box according to the invention shown in FIG. 2.

The antenna input terminal 4 receives a broadcast signal received by an antenna (not shown). The terrestrial digital tuner unit 5 channel selects a broadcast to be received from among broadcast signals received by the antenna input terminal 4, down-converts it, and then outputs it to the demodulation part 6. The signal outputted from the terrestrial digital tuner unit 5 is demodulated in the demodulation part 6, and decoded into an audio signal and a video signal in the MPEG decoder 7. The audio signal is outputted from the audio signal output terminal 8, and the video signal is outputted from the video signal output terminal 9. The audio signal output terminal 8 is connected via a cable to an audio signal external input terminal 1A of the analog TV 1, and the video signal output terminal 9 is connected via a cable to a video signal external input terminal 1V of the analog TV 1. As a result, when the analog TV 1 selects external input and only the set top box according to the invention is externally connected to the analog TV 1, the analog TV 1 performs display based on a video signal outputted from the STB main body 2 and audio output based on an audio signal outputted from the STB main body 2.

An infrared signal transmitted from an infrared remote control transmitter through infrared data communication and received by the light receiving part 10 is converted into an electrical signal in the light receiving part 10, demodulated into remote control code data in the remote control code demodulation part 11, and then transmitted to the vendor-type-function determination part 15 and the data-through switch 12.

The vendor-type-function determination part 15, with reference to individual vendor remote control code table data previously stored in the individual vendor remote control code table data storage part 14, identifies a vender name, a type name, and a function name corresponding to the remote control code data transmitted from the remote control code demodulation part 11, and transmits results of this identification to the remote control code conversion and control part 13 and the data-through switch 12. The individual vendor remote control code table data is in a table form including remote control code data on an analog TV sold in the past and remote control code data on the set top box according to the invention (see FIG. 2).

If the results of identification show that the type name is a set top box (“STB” in step #10 of FIG. 2), the data-through switch 12 selects only a contact b in accordance with the results of identification made by the vendor-type-function determination part 15, so that the remote control code data sent out from the remote control code demodulation part 11 is transmitted to the remote control code conversion and control part 13, which, without converting the remote control code data, controls the terrestrial digital tuner unit 5 and the various other portions of the STB main body 2 so as to realize the function assigned to the remote control code data (step #20 of FIG. 2). As a result, even by use of the STB remote control transmitter attached to the set top box according to the invention, the set top box according to the invention can be remotely controlled without any problem.

If the results of identification shows that the type name is neither the set top box nor the analog TV (“Others” in step #10 of FIG. 2), the data-through switch 12 selects neither contacts a and b in accordance with the results of identification made by the vendor-type-function determination part 15. As a result, an infrared signal transmitted from an infrared remote control transmitter other than the analog TV remote control transmitter attached to the analog TV sold in the past and the STB remote control transmitter attached to the set top box according to the invention is ignored, which can prevent erroneous operation.

If the results of identification shows that the type name is an analog TV (“Analog TV” in step #10 of FIG. 2) and that the function name corresponds to none of power ON/OFF switching, input switching, and channel switching (“No” in step #30 of FIG. 2), the data-through switch 12 selects only the contact a in accordance with the results of identification made by the vendor-type-function determination part 15, so that remote control code data sent out from the remote control code demodulation part 11 passes through the STB main body 2 and then is transmitted from the terminal 16 to the remote control transfer part 3. The remote control code data outputted from the terminal 16 of the STB main body 2 is inputted via the cable to the terminal 17 of the remote control transfer part 3, modulated in the remote control code modulation part 18 of the remote control transfer part 3, then converted into an infrared signal in the light emitting part 19, and transmitted toward the light receiving part 1P of the analog TV 1 (step #40 of FIG. 2). As a result, for example, when the viewer presses the volume adjustment key of the analog TV remote control transmitter 20 and an infrared signal transmitted by the analog TV remote control transmitter 20 in response to this pressing operation is received by the light receiving part 10 of the STB main body 2, the volume of audio output from the analog TV 1 is changed without any problem.

If the results of identification shows that the type name is an analog TV (“Analog TV” in step #10 of FIG. 2) and that the function name corresponds to any of the power ON/OFF switching, input switching, and channel switching (“Yes” in step #30 of FIG. 2), control in accordance with the corresponding function is executed (step #50).

If the results of identification shows that the type name is an analog TV and that the function name corresponds to power ON/OFF switching, the data-through switch 12 selects both of the contacts a and b in accordance with the results of identification made by the vendor-type-function determination part 15, so that remote control code data sent out from the remote control code demodulation part 11 passes through the STB main body 2 and then is transmitted from the terminal 16 to the remote control transfer part 3 and also to the remote control code conversion and control part 13. The remote control code data outputted from the terminal 16 of the STB main body 2 is inputted via the cable to the terminal 17 of the remote control transfer part 3, modulated in the remote control code modulation part 18 of the remote control transfer part 3, then converted into an infrared signal in the light emitting part 19, and transmitted toward the light receiving part 1P of the analog TV 1. As a result, switching occurs in the power ON/OFF of the analog TV 1. The remote control code conversion and control part 13 converts the remote control code data sent out from the remote control code demodulation part 11 into remote control code data corresponding to STB power ON/OFF switching function and then controls the various portions of the STB main body 2 in accordance with this converted remote control code. As a result, switching occurs in the power ON/OFF of the STB main body 2.

If the results of identification show that the type name is an analog TV and that the function name corresponds to the input switching, the data-through switch 12 selects neither of the contacts a and b in accordance with the results of identification made by the vendor-type-function determination part 15. As a result, even when the input switch key of the analog TV remote control transmitter 20 is pressed under the condition that the analog TV 1 selects external output and only the set top box according to the invention is externally connected to the analog TV 1, switching to analog broadcast viewing does not occur, and the analog TV 1 continues performing display based on a vide signal outputted from the STB main body 2 and audio output based on an audio signal outputted from the STB main body 2.

If the results of identification shows that the type name is an analog TV and that the function name corresponds to the channel switching, the data-through switch 12 selects only the contact b in accordance with the results of identification made by the vendor-type-function determination part 15, so that remote control code data sent out from the remote control code demodulation part 11 is transmitted to the remote control code conversion and control part 13. The remote control code conversion and control part 13 converts the remote control code data sent out from the remote control code demodulation part 11 into remote control code data corresponding to STB channel switching function, and controls the terrestrial digital tuner unit 5 and the various other portions of the STB main body 2 in accordance with the converted remote control code. As a result, even when the channel switch key of the analog TV remote control transmitter 20 is pressed under the condition that the analog TV 1 selects external output and only the set top box according to the invention is external connected to the analog TV 1, switching to analog broadcast viewing does not occur, and the analog TV 1 continues performing display based on a vide signal outputted from the STB main body 2 and audio output based on an audio signal outputted from the STB main body 2, and further can change the channel of digital broadcast currently viewed.

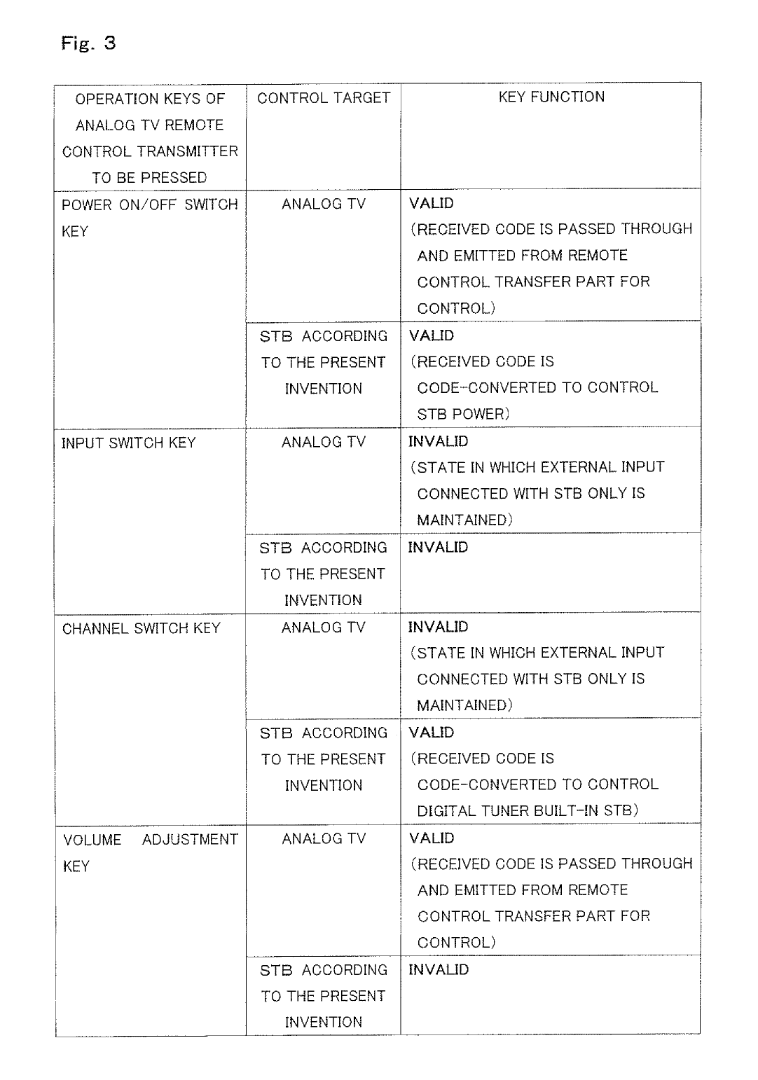

The set top box according to the invention performs operation as described above. Thus, when the viewer presses an arbitrary operation key of the analog TV remote control transmitter 20 and then an infrared signal transmitted from the analog TV remote control transmitter 20 in response to the pressing operation is received by the light receiving part 10 of the STB main body 2, key functions on the analog TV 1 and the set top box according to the invention are as shown in FIG. 3.

What is claimed is:

1. A set top box, in combination with an analog TV, forming a digital broadcast viewing system, the set top box comprising:
a digital tuner unit for digital broadcast reception;
an output terminal for externally outputting a signal based on an output signal of the digital tuner unit; and
a blocking part for covering a light receiving part of the analog TV to prevent the light receiving part of the analog TV from directly receiving a signal transmitted from an analog TV remote control transmitter.

2. The set top box according to claim 1, further comprising a remote control light receiving part receiving the signal transmitted from the analog TV remote control transmitter.

3. The set top box according to claim 2, further comprising:
a demodulation part demodulating an output signal of the remote control light receiving part to obtain remote control code data;
a determination part determining, based on the remote control code data obtained by the demodulation part, whether or not the signal transmitted from the analog TV remote control transmitter is a signal transmitted when a predetermined operation key of the analog TV remote control transmitter is pressed; and
a transfer part, when the determination part determines that the signal transmitted from the analog TV remote control transmitter is the signal transmitted when the predetermined operation key of the analog TV remote control transmitter is pressed, restoring the signal transmitted from the analog TV remote control transmitter and transferring the signal to permit the light receiving part of the analog TV to directly receive the signal.

4. The set top box according to claim 3,
wherein the predetermined operation key does not include an input switch key and a channel switch key.

5. The set top box according to claim 2, further comprising,
a demodulation part demodulating an output signal of the remote control light receiving part to obtain remote control code data;
a determination part determining, based on the remote control code data obtained by the demodulation part, whether or not the signal transmitted from the analog TV remote control transmitter is a signal transmitted when a channel switch key of the analog TV remote control transmitter is pressed; and
a remote control code conversion and control part, when the determination part determines that the signal transmitted from the analog TV remote control transmitter is the signal transmitted when the channel switch key of the analog TV remote control transmitter is pressed, converting the remote control code data obtained by the demodulation part into set top box channel switching remote control code data and controls the digital tuner unit in accordance with the set top box channel switching remote control code data.

6. The set top box according to claim 3, further comprising,
a determination par determining, based on the remote control code data obtained by the demodulation part, whether or not the signal transmitted from the analog TV remote control transmitter is a signal transmitted when a channel switch key of the analog TV remote control transmitter is pressed; and
a remote control code conversion an control part, when the determination part determines that the signal transmitted from the analog TV remote control transmitter is the signal transmitted when the channel switch key of the analog TV remote control transmitter is pressed, converting the remote control code data obtained by the demodulation part into set top box channel switching remote control code data and controls the digital tuner unit in accordance with the set top box channel switching remote control code data.

7. The set top box according to claim 4, further comprising,
a determination part determining, based on the remote control code data obtained by the demodulation part, whether or not the signal transmitted from the analog TV remote control transmitter is a signal transmitted when a channel switch key of the analog TV remote control transmitter is pressed; and
a remote control code conversion an control part, when the determination part determines that the signal transmitted from the analog TV remote control transmitter is the signal transmitted when the channel switch key of the analog TV remote control transmitter is pressed, converting the remote control code data obtained by the demodulation part into set top box channel switching remote control code data and controls the digital tuner unit in accordance with the set top box channel switching remote control code data.

8. A digital broadcast viewing system comprising a set top box and an analog TV externally receiving a signal outputted from an output terminal of the set top box,
wherein the set top box comprises.
a digital tuner unit for digital broadcast reception;
the output terminal for externally outputting a signal based on an output signal of the digital tuner unit; and
a blocking part for covering a light receiving part of the analog TV to prevent the light receiving part of the analog TV from directly receiving a signal transmitted from an analog TV remote control transmitter.

9. The digital broadcast viewing system according to claim 8,
wherein the set top box further comprises a remote control light receiving part receiving the signal transmitted from the analog TV remote control transmitter.

10. The digital broadcast viewing system according to claim 9,
wherein the set top box further comprises:
a demodulation part demodulating an output signal of the remote control light receiving part to obtain remote control code data;
a determination part determining, based on the remote control code data obtained by the demodulation part, whether or not the signal transmitted from the analog TV remote control transmitter is a signal transmitted when a predetermined operation key of the analog TV remote control transmitter is pressed; and
a transfer part, when the determination part determines that the signal transmitted from the analog TV remote control transmitter is the signal transmitted when the predetermined operation key of the analog TV remote control transmitter is pressed, restoring the signal transmitted from the analog TV remote control transmitter and transferring the signal to permit the light receiving part of the analog TV to directly receive the signal.

11. The digital broadcast viewing system according to claim 10,
wherein the predetermined operation key does not include an input switch key and a channel switch key.

12. The digital broadcast viewing system according to claim 9,
wherein the set top box further comprises:
a demodulation part demodulating an output signal of the remote control light receiving part to obtain remote control code data;
a determination part determining, based on the remote control code data obtained by the demodulation part, whether or not the signal transmitted from the analog TV remote control transmitter is a signal transmitted when a channel switch key of the analog TV remote control transmitter is pressed; and
a remote control code conversion and control part, when the determination part determines that the signal transmitted from the analog TV remote control transmitter is the signal transmitted when the channel switch key of the analog TV remote control transmitter is pressed, converting the remote control code data obtained by the demodulation part into set top box channel switching remote control code data and controls the digital tuner unit in accordance with the set top box channel switching remote control code data.

13. The digital broadcast viewing system according to claim 10,
wherein the set top box further comprises:
a determination part determining, based on the remote control code data obtained by the demodulation part, whether or not the signal transmitted from the analog TV remote control transmitter is a signal transmitted when a channel switch key of the analog TV remote control transmitter is pressed; and
a remote control code conversion an control part, when the determination part determines that the signal transmitted from the analog TV remote control transmitter is the signal transmitted when the channel switch key of the analog TV remote control transmitter is pressed, converting the remote control code data obtained by the demodulation part into set top box channel switching remote control code data and controls the digital tuner unit in accordance with the set top box channel switching remote control code data.

14. The digital broadcast viewing system according to claim 11,
wherein the set top box further comprises:
a determination part determining, based on the remote control code data obtained by the demodulation part, whether or not the signal transmitted from the analog TV remote control transmitter is a signal transmitted when a channel switch key of the analog TV remote control transmitter is pressed; and
a remote control code conversion an control part, when the determination part determines that the signal transmitted from the analog TV remote control transmitter is the signal transmitted when the channel switch key of the analog TV remote control transmitter is pressed, converting the remote control code data obtained by the demodulation part into set top box channel switching remote control code data and controls the digital tuner unit in accordance with the set top box channel switching remote control code data.

15. A method of controlling a digital broadcast viewing system formed by a combination of an analog TV and a set top box having a digital tuner unit for digital broadcast reception, the method preventing a light receiving part of the analog TV from directly receiving a signal transmitted from an analog TV remote control transmitter.

16. The method of controlling a digital broadcast viewing system according to claim 15, wherein the set top box:
receiving the signal transmitted from the analog TV remote control transmitter, demodulating the received signal to obtain remote control code data;
determining, based on the obtained remote control code data, whether or not the signal transmitted from the analog TV remote control transmitter is a signal transmitted when a predetermined operation key of the analog TV remote control transmitter is pressed; and
when it is determined that the signal transmitted from the analog TV remote control transmitter is the signal transmitted when the predetermined operation key of the analog TV remote control transmitter is pressed, restores the signal transmitted from the analog TV remote control transmitter and transfers the signal to permit the light receiving part of the analog TV to directly receive the signal.

17. The method of controlling a digital broadcast viewing system according to claim 16,
wherein the predetermined operation key does not include an input switch key and a channel switch key.

18. The method of controlling a digital broadcast viewing system according to claim 15, wherein the set top box:
receives the signal transmitted from the analog TV remote control transmitter;
demodulates the received signal to obtain remote control code data;
determines, based on the obtained remote control code data, whether or not the signal transmitted from the analog TV remote control transmitter is a signal transmitted when a channel switch key of the analog TV remote control transmitter is pressed; and
when it is determined that the signal transmitted from the analog TV remote control transmitter is the signal transmitted when the channel switch key of the analog TV remote control transmitter is pressed, converts the remote control code data into set top box channel switching remote control code data and controls the digital tuner unit in accordance with the set top box channel switching remote control code data.

19. The method of controlling a digital broadcast viewing system according to claim 16, wherein the set top box:
determines, based on the obtained remote control code data, whether or not the signal transmitted from the analog TV remote control transmitter is a signal transmitted when a channel switch key of the analog TV remote control transmitter is pressed; and
when it is determined that the signal transmitted from the analog TV remote control transmitter is the signal transmitted when the channel switch key of the analog TV remote control transmitter is pressed, converts the remote control code data into set top box channel switching remote control code data and controls the digital tuner unit in accordance with the set top box channel switching remote control code data.

20. The method of controlling a digital broadcast viewing system according to claim 17, wherein the set top box:
determines, based on the obtained remote control code data, whether or not the signal transmitted from the analog TV remote control transmitter is a signal transmitted when a channel switch key of the analog TV remote control transmitter is pressed; and
when it is determined that the signal transmitted from the analog TV remote control transmitter is the signal transmitted when the channel switch key of the analog TV remote control transmitter is pressed, converts the remote control code data into set top box channel switching remote control code data and controls the digital tuner unit in accordance with the set top box channel switching remote control code data.
